(19) United States
(12) Patent Application Publication
(10) Pub. No.: US 2025/0016195 A1
(43) Pub. Date: Jan. 9, 2025

(54) SYSTEM AND METHOD FOR DETECTION OF CYBERSECURITY THREATS

(71) Applicant: FOUR DROBOTICS CORPORATION, Ottawa (CA)

(72) Inventors: Jeremy James, Ottawa (CA); Deyan Zhu, Ottawa (CA)

(21) Appl. No.: 18/892,884

(22) Filed: Sep. 23, 2024

Related U.S. Application Data
(63) Continuation of application No. PCT/IB2023/052734, filed on Mar. 21, 2023.
(60) Provisional application No. 63/323,478, filed on Mar. 24, 2022.

(51) Int. Cl. H04L 9/40

(52) U.S. Cl. CPC H04L 63/1466

(57) ABSTRACT

A method for detecting a man-in-the-middle attack on an encrypted set of data comprising: hashing, by a source hashing subsystem within a source, the encrypted set of data to create a source hash; transmitting, by a source communications subsystem within the source, the encrypted set of data to a destination using a first channel which couples the source and the destination; transmitting, by the source communications subsystem, the source hash to the destination using a second channel which couples the source and the destination; hashing, by a destination hashing subsystem within the destination, the encrypted set of data to create a destination hash; comparing, by a comparison subsystem within the destination, the source hash with the destination hash; and detecting, by at least one of the comparison subsystem and a destination processor, a presence or an absence of the man-in-the-middle attack based on the comparing.

The instant application claims priority to PCT application PCT/IB2023/052734 with an international filing date of Mar. 21, 2023, presently pending, which in turn claimed priority to U.S. provisional application 63/323,478, filed on Mar. 24, 2022, presently expired. The contents of each application is hereby incorporated by reference.

### FIELD OF THE INVENTION

The present disclosure relates to the detection of cybersecurity threats, in particular, the detection of man-in-the-middle attacks.

### BRIEF SUMMARY

In one aspect, a system for detecting a man-in-the-middle attack on an encrypted set of data between a source and a destination, wherein a plurality of channels couples the source and the destination. The source comprises a source communications subsystem coupled to the plurality of channels, a source processor, and a source hashing subsystem. The source communications subsystem, source processor, and source hashing subsystem are coupled with each other. The destination comprises a destination communications subsystem coupled to the plurality of channels, a destination hashing subsystem, a comparison subsystem, and a destination processor. The destination communications subsystem, destination hashing subsystem, comparison subsystem and destination processor are coupled with each other. The source hashing subsystem hashes the encrypted set of data to create one or more copies of a source hash. The source communications subsystem transmits the encrypted set of data to the destination using a first of the plurality of channels. The source communications subsystem transmits the one or more copies of the source hash to the destination using one or more of the plurality of channels other than the first channel. The destination communications subsystem receives the encrypted set of data from the first channel, and the one or more copies of the source hash from the one or more of the plurality of channels other than the first channel. The destination hashing subsystem hashes the received encrypted set of data to create a destination hash. The comparison subsystem compares the one or more copies of the source hash with each other and the destination hash. At least one of the comparison subsystem and the destination processor detects a presence or an absence of the man-in-the-middle attack based on the comparison.

In another aspect, a method for detecting a man-in-the-middle attack on an encrypted set of data comprises hashing, by a source hashing subsystem within a source, the encrypted set of data to create a source hash; transmitting, by a source communications subsystem within the source, the encrypted set of data to a destination using a first channel which couples the source and the destination; transmitting, by the source communications subsystem, the source hash to the destination using a second channel which couples the source and the destination; hashing, by a destination hashing subsystem within the destination, the encrypted set of data to create a destination hash; comparing, by a comparison subsystem within the destination, the source hash with the destination hash; and detecting, by at least one of the comparison subsystem and a destination processor, a presence or an absence of the man-in-the-middle attack based on the comparing.

In another aspect, a system for detecting a man-in-the-middle attack on a first channel which couples a source and a destination, wherein a second channel couples the source and the destination. The source comprises a source communications subsystem coupled to the first and the second channels, a source processor, and a source hashing subsystem. The source communications subsystem, source processor and source hashing subsystem are coupled with each other. The destination comprises a destination processor, a destination communications subsystem coupled to the first and the second channels, a destination hashing subsystem, and a comparison subsystem. The destination communications subsystem, destination processor, comparison subsystem, and source hashing subsystem are coupled with each other. The source processor creates an encrypted first set of data. The source hashing subsystem hashes the encrypted first set of data to create a source hash. The source communications subsystem transmits the encrypted first set of data to the destination using the first channel. The source communications subsystem transmits the source hash to the destination using the second channel. The destination communications subsystem receives the encrypted first set of data from the first channel and the source hash from the second channel. The destination hashing subsystem hashes the encrypted first set of data to create a destination hash. The comparison subsystem compares the source hash with the destination hash. At least one of the comparison subsystem and the destination processor detects a presence or an absence of the man-in-the-middle attack based on the comparison.

In another aspect, a method for detecting a man-in-the-middle attack on an encrypted set of data, the method comprising: hashing, by a source hashing subsystem within a source, the encrypted set of data to create one or more copies of a source hash; transmitting, by a source communications subsystem within the source, the encrypted set of data to a destination using a first of a plurality of channels, wherein the plurality of channels couples the source and the destination; transmitting, by the source communications subsystem, the one or more copies of the source hash to the destination using one or more channels from the plurality of channels other than the first channel; hashing, by a destination hashing subsystem within the destination, the encrypted set of data to create a destination hash; comparing, by a comparison subsystem within the destination, the one or more copies of the source hash with the destination hash; and detecting, by at least one of the comparison subsystem and a destination processor, a presence or an absence of the man-in-the-middle attack based on the comparing.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is an illustration of an example of a source-destination communications setup.

FIG. 2 is an illustration of an example of a man-in-the-middle attack.

FIG. 3 is an illustration of an example embodiment of a system to detect the presence or absence of a man-in-the-middle attack.

FIG. 4 is an illustration of an example embodiment of a process to detect the presence or absence of a man-in-the-middle attack.

FIG. 5 is an illustration of an example of detection of a man-in-the-middle attack.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

A “man-in-the-middle” attack is a type of eavesdropping attack, where the attacker(s) interrupt an existing conversation or data transfer. The attacker(s) insert themselves in the “middle” of a communications channel and pretend to be legitimate participants. This enables an attacker to intercept information and data from a source while also sending a list of links which are malicious or other misinformation to a destination in a way that might not be detected until it is too late.

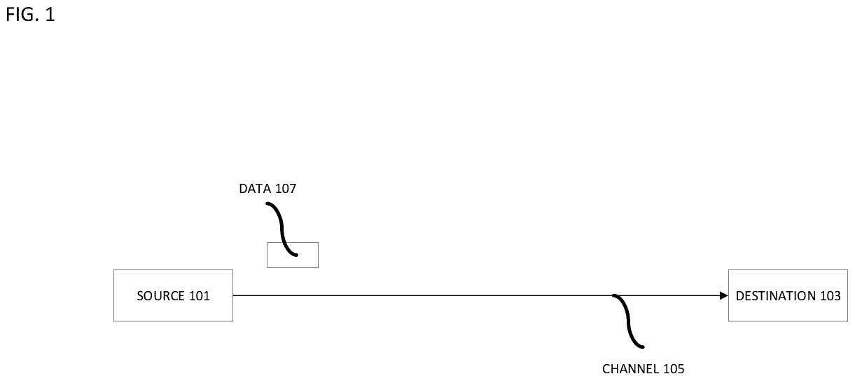

FIG. 1 shows an example of a source-destination communications setup. Source 101 is communicatively coupled with destination 103 via channel 105; and communicates data 107 with destination 103 using channel 105. In some embodiments, source 101 comprises, for example, a sensor such as a camera, RADAR, LIDAR or any appropriate type of device; or computing device. Data 107 comprises different types of data. In some embodiments, data 107 comprises, for example, sensor data, or command and control data. In some embodiments, channel 105 is a direct channel, that is, it directly couples source 101 with destination 103. Therefore, the channel 105 comprises only one link between source and destination. In other embodiments, channel 105 is an indirect channel, that is, it couples source 101 with destination 103 via at least one intermediate node. Therefore, the channel comprises two or more links between the source 101 and destination 103. At least one of these links are coupled to an intermediate node. Each of the links and channels described above may be wired, wireless or a combination of wired and wireless. These links use communications technologies known to those of skill in the art, for example, 4G, 5G, BLUETOOTH, Ethernet, Universal Serial Bus (USB) and other communications technologies suitable for wired and wireless communications. In some embodiments, data 107 is encrypted by source 101 before transmission to destination 103 via channel 105.

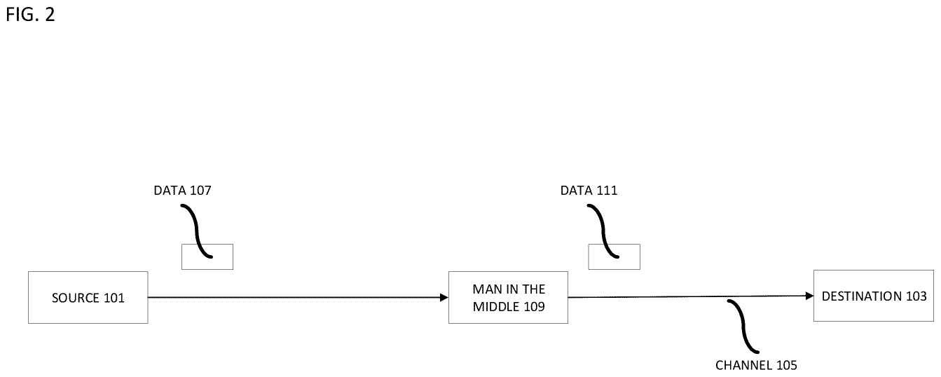

FIG. 2 shows an example of a man-in-the-middle attack for the setup of FIG. 1. In FIG. 2, man-in-the-middle (MITM) 109 has inserted itself in the middle of channel 105, between source 101 and destination 103. MITM 109 has broken the encryption used by source 101. Then data 107 in channel 105 has been intercepted by MITM 109, and, if necessary, decrypted by MITM 109 and read. MITM 109 then manipulates the data 107 to create new data 111, encrypts the new data 111 and sends this on to destination 103. Destination 103 does not detect that anything has happened and incorrectly trusts that data 111 was sent by source 101. Examples of such manipulation comprise erasing or modifying an image of a human, or changing a control signal to turn an unmanned vehicle left instead of right, or changing geolocation information.

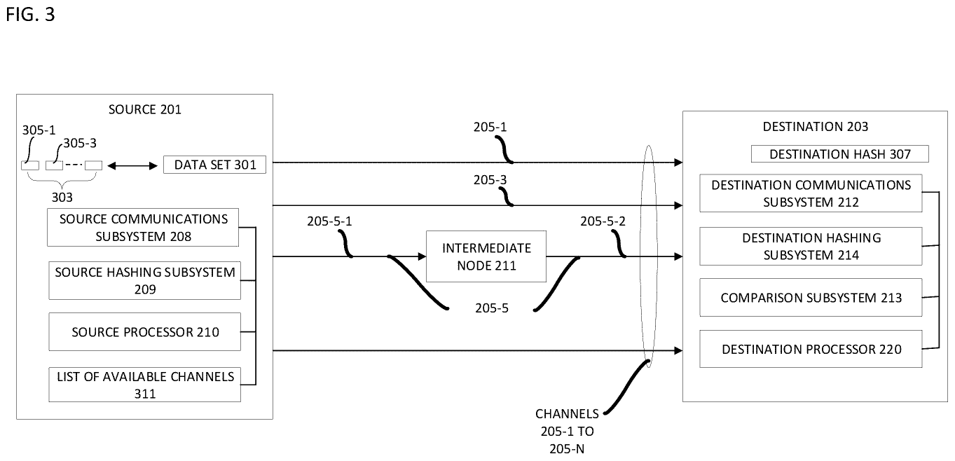

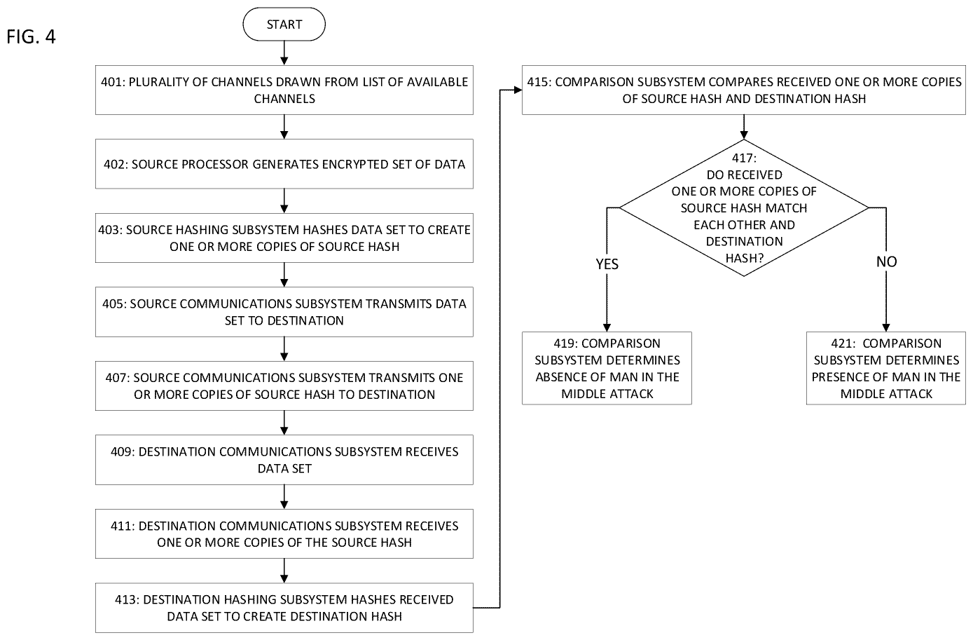

FIGS. 3 and 4 show an example embodiment of the system and method to detect the presence or absence of the man-in-the-middle attack demonstrated in FIG. 2, which is the subject of this specification.

In FIG. 3, source 201 and destination 203 are coupled by one or more channels 205-1 to 205-N. In some embodiments, source 201 comprises source communications subsystem 208, source hashing subsystem 209, and source processor 210. Source communications subsystem 208, source hashing subsystem 211, and source processor 210 are coupled to one another.

Destination 203 comprises destination communications subsystem 212, destination hashing subsystem 211, comparison subsystem 213, and destination processor 220. Destination communications subsystem 212, destination hashing subsystem 211, comparison subsystem 213 and destination processor 220 are coupled to each other.

Source communications subsystem 208 is coupled to one or more channels 205-1 to 205-N. Source communications subsystem 208 comprises at least one of hardware and software to enable source 201 to receive information from, and transmit information to, one or more channels 205-1 to 205-N. Source communications subsystem 208 communicates with channels 205-1 to 205-N using the communications and networking protocols and techniques that one or more channels 205-1 to 205-N utilize. In some embodiments, source communications subsystem 208 on its own, or in combination with source processor 210, performs monitoring and evaluation of channels 205-1 to 205-N. In some embodiments where source communications subsystem 208 performs these operations on its own, it then communicates the results of these operations to source processor 210.

Source hashing subsystem 209 implements one or more hashing schemes known to those of skill in the art within source 201. Examples of such schemes comprise Message Digest (MDx) algorithms, and Secure Hash Algorithms (SHA). In some embodiments, source hashing subsystem 209 is part of source processor 210. In some embodiments, source hashing subsystems 209 is implemented in software. In some embodiments, source hashing subsystems 209 is implemented in hardware. In some embodiments, source hashing subsystems 209 is implemented using both software and hardware.

Source processor 210 acts to coordinate and perform processing necessary for the operation of source 201. In some embodiments, source processor 210 performs one or more functions such as:
maintaining and updating list of available channels 311, as will be explained below;
performing operations necessary to select a plurality of channels 205-1 to 205-N from list of available channels 311, as will be explained below; and
performing encryption of data sets to generate encrypted data sets such as data set 301 for transmission over channels 205-1 to 205-N.
   To perform these functions, source processor 210 stores, for example, cryptographic keys and implements programs necessary for encryption and decryption of data sets. In some embodiments, source processor 210 is implemented using a combination of hardware and software. As explained above, in some embodiments source processor 210 comprises source hashing subsystem 209.

In some embodiments, source 201 is implemented in a distributed manner using a plurality of devices. For example, source hashing subsystem 209, source processor 210 and list of available channels 311 is implemented on a first device, while source communications subsystem 208 is implemented on a second device which is communicatively coupled to the first device. One of skill in the art would know that this is not the only distributed configuration that is possible, and that other distributed configurations are also possible. In other embodiments, source 201 is communicatively coupled to a subsystem or a device such as a sensor, and receives unencrypted or encrypted data sets from the subsystem or sensor. Then, source 201 can perform encryption, when needed, and detection of man-in-the-middle attacks for the sensor. In this way, costly or difficult upgrades need not be performed for the sensor to enable detection of man-in-the-middle attacks.

Destination communications subsystem 212 is coupled to one or more channels 205-1 to 205-N. Destination communications subsystem 212 comprises at least one of hardware and software to enable destination 203 to receive information from, and transmit information to, one or more channels 205-1 to 205-N. Destination communications subsystem 212 communicates with channels 205-1 to 205-N using the communications and networking protocols and techniques that one or more channels 205-1 to 205-N utilize.

Destination hashing subsystem 214 implements one or more hashing schemes known to those of skill in the art within destination 203. Destination hashing subsystem 214 is similar to source hashing subsystem 209. In some embodiments, destination hashing subsystem 214 is part of destination processor 220. In some embodiments, destination hashing subsystem 214 is implemented in software. In some embodiments, destination hashing subsystem 214 is implemented in hardware. In some embodiments, destination hashing subsystem 214 is implemented using both software and hardware.

Comparison subsystem 213 acts to compare two or more digital hashes to each other. As will be explained below, these two or more digital hashes comprise, for example, hashes created by source hashing subsystem 209 and transmitted via channels 205-1 to 205-N; or hashes created by destination hashing subsystem 214. In some embodiments, comparison subsystem 213 is part of destination processor 220. In some embodiments, comparison subsystem 213 is implemented in software. In some embodiments, comparison subsystem 213 is implemented in hardware. In some embodiments, comparison subsystem 213 is implemented using both software and hardware.

Destination processor 220 acts to coordinate and perform processing necessary for the operation of destination 203. In some embodiments, destination processor 220 performs one or more functions such as performing decryption of encrypted data sets and other information received over channels 205-1 to 205-N. In these embodiments, destination processor 220 stores, for example, cryptographic keys and implements programs necessary for encryption and decryption of data sets. In some embodiments, destination processor 220 is implemented using a combination of hardware and software. As explained above, in some embodiments destination processor 220 comprises at least one of source hashing subsystem 209 and comparison subsystem 213.

In some embodiments, destination 203 is implemented in a distributed manner using a plurality of devices. For example, destination hashing subsystem 214, destination processor 220 and comparison subsystem 213 is implemented on a first device, while destination communications subsystem 212 is implemented on a second device which is communicatively coupled to the first device. One of skill in the art would know that this is not the only distributed configuration that is possible, and that other distributed configurations are also possible. In other embodiments, destination 203 is communicatively coupled to a different subsystem or device, and performs detection of man-in-the-middle attacks for that different subsystem or device. In this way, costly or difficult upgrades need not be performed for the different subsystem or device to enable detection of man-in-the-middle attacks.

Each of channels 205-1 to 205-N is similar to channel 105. Each of these channels are, for example, direct or indirect. For example, channel 205-5 couples source 201 and destination 203 via intermediate node 211. Channel 205-5 comprises links 205-5-1 and 205-5-2. Link 205-5-1 couples source 201 and intermediate node 211. Link 205-5-2 couples intermediate node 211 and destination 203. Similar to as described above, in some embodiments, data such as set of data 301 is encrypted by source 201 before transmission to destination 203 via any of the plurality of channels 205-1 to 205-N.

To create the plurality of channels 205-1 to 205-N, one or more techniques known to those of skill in the art are used. The source and destination communications subsystems are appropriately configured using techniques known to those of skill in the art, so as to transmit and receive over the plurality of channels. In some embodiments, each of the plurality of channels occupy non-overlapping frequency ranges.

In some embodiments, the plurality of channels 205-1 to 205-N are drawn from a list of available channels 311 of FIG. 3. In some of these embodiments, the plurality of channels 205-1 to 205-N is all the channels on the list of available channels 311. In some of these embodiments, the plurality of channels 205-1 to 205-N is selected from the list of available channels 311.

The selecting is based on one or more criteria, which will now be described.

In some embodiments, the selecting is based on signal quality. For example, source processor 210 either collects data or receives data to enable various measures of signal quality to be calculated for each of the channels on the list of available channels. These measures comprise, for example, signal-to-noise ratio (SNR), signal to interference and noise ratio (SINR) and bit error rate (BER). In some embodiments, the source processor 210 collects this information, and then together with the source communications subsystem 208 calculates measures such as SNR, SINR and BER. In another embodiment, the source communications subsystem 208 calculates these measures on its own. In a further embodiment, the source processor 210 together with the source communications subsystem 208 calculates a signal quality score for each channel on the list of available channels based on a function that takes in one or more of signal quality measures such as SNR, SINR and BER as inputs, and produces the score as the output. For example, in one embodiment the source processor 210 calculates a weighted average based on SNR and SINR. In another embodiment, a weighted average is first calculated, then compared against a threshold and used to calculate a performance score. The source processor 210 can also store historical signal quality information and other information for future use.

In other embodiments, the selecting is based on link quality. For example, source processor 210 either collects data or receives data to enable various measures of link quality to be calculated for each of the channels on the list of available channels. These measures comprise, for example, packet error rate (PER), packet jitter, intermediate node load and throughput. Similar to signal quality, in some embodiments the source processor 210 collects this information, and then together with the source communications subsystem 208 calculates measures such as PER, jitter and throughput. In other embodiments, the source communications subsystem 208 calculates these measures on its own. In further embodiments, the source processor 210 together with the source communications subsystem 208 calculates a link quality score based on a function which takes in one or more of link quality measures such as PER, jitter and throughput as inputs, and produces the score as the output. For example, in some embodiments the source processor 210 calculates a weighted average based on PER and jitter. In other embodiments, a weighted average is first calculated, then compared against a threshold, and used to calculate a performance score. In some embodiments, the source processor also stores historical link quality information, and other information for future use.

In other embodiments, the selecting is based on geolocation information. Then, the source processor 210 uses geolocation information, for example, the location of the source 201 relative to the destination 203, latitude of the source, longitude of the source, latitude of the destination and longitude of the destination, to select the plurality of channels 205-1 to 205-N. This geolocation information is obtained, for example, from sensors coupled to the source.

In other embodiments, the selecting is based on positional or motion information. This positional or motion information is obtained, for example, from sensors coupled to the source; and are used by the source processor 210 to select the plurality of channels. Examples of positional or motion information include velocity of the source, acceleration of the source, direction of travel of the source, orientation of the source, angular velocity of the source, angular acceleration of the source and altitude of source.

In other embodiments, the plurality of channels 205-1 to 205-N is selected by source processor 210 based on user input and instructions supplied to source processor 210 using one or more interfaces with source processor 210.

In some embodiments, the selecting of a plurality of channels 205-1 to 205-N comprises ranking the list of available channels based on the one or more criteria described above. Then a subset of the available channels is selected based on the rankings. For example, the highest ranked N out of a list of M available channels, where N<M, are selected.

In some embodiments, the selecting of plurality of channels 205-1 to 205-N comprises comparing each of the channels on the list of available channels 311 to one or more thresholds. In some embodiments, the one or more thresholds are based on the above described one or more criteria. Then, for example, any of the one or more channels on the list of available channels 311 which do not meet the one or more thresholds, are not included in the plurality of channels 205-1 to 205-N.

In some embodiments, the selecting of plurality of channels 205-1 to 205-N comprises combining ranking of the list of available channels; and comparing against the one or more thresholds. For example, the channels on the list of available channels which do not meet the one or more thresholds are removed from consideration for selection for the plurality of channels. The remaining channels are then ranked and a subset of the remaining channels are selected for the plurality of channels 205-1 to 205-N.

In further embodiments, as explained above, source processor 210 maintains and updates the list of available channels 311 of FIG. 3. In some of these embodiments, channels are removed and added by source processor 210 from the list of available channels 311 based on the one or more criteria described above, that is, signal quality, link quality, geolocation information, positional or motion information, and user input.

An example of the operation of the system and method is now described below with reference to FIGS. 3 and 4.

In step 401, the plurality of channels 205-1 to 205-N to be used are drawn or selected from the list of available channels 311 by the source processor 210 using the processes described above.

In step 402 of FIG. 4, source processor 210 of FIG. 3 generates an encrypted set of data 301 using, for example, cryptographic keys and programs stored within source processor 210.

In step 403 of FIG. 4, source hashing subsystem 209 of FIG. 3 hashes encrypted data set 301 to create one or more copies of a source hash 303.

In step 405 of FIG. 4, source communications subsystem 208 transmits encrypted data set 301 to destination 205 using, for example, channel 205-1 of FIG. 3. In the embodiment shown in FIG. 3, channel 205-1 is a direct channel.

In step 407 of FIG. 4, source communications subsystem 208 transmits one or more copies of source hash 303 to destination 203 using each of a one or more of the plurality of channels other than the channel 205-1 used to transmit the set of data. For example, source transceiver 208 transmits two copies 305-1 and 305-3 of source hash 303 to destination 203 using channels 205-3 and 205-5.

In step 409 of FIG. 4, destination communications subsystem 212 in destination 203 receives set of data 301 from channel 205-1.

In step 411 of FIG. 4, destination communications subsystem 212 receives the one or more copies of the source hash from the one or more of the plurality of channels other than the channel 205-1 used to transmit the set of data. For example, destination communications subsystem 212 receives two copies 305-1 and 305-3 from channels 205-3 and 205-5.

In step 413 of FIG. 4, destination hashing subsystem 214 hashes the received set of data 301 to create destination hash 307.

In step 415, comparison subsystem 213 compares the received one or more copies of the source hash, for example, copies 305-1 and 305-3, with each other and the destination hash 307.

When the received one or more copies of the source hash match each other and the destination hash in step 417, then in some embodiments, the comparison subsystem 213 determines in step 419 that there is no man-in-the-middle attack, or that there is an absence of a man-in-the-middle attack. When, in step 417, there is a mismatch between the received one or more copies of the source hash, or there is a mismatch with the destination hash, then in some embodiments, the comparison subsystem 213 determines the presence of a possible man-in-the-middle attack in step 421. In some embodiments, the presence or absence of a man-in-the-middle attack is performed by either the comparison subsystem 213 or the destination processor 220.

In some embodiments, in step 421, when the presence of a possible man-in-the-middle attack is detected by comparison subsystem 213, then destination processor 220 sends encrypted instructions to source 201 to remove one or more of the plurality of channels 205-1 to 205-N from the list of available channels 311. So as to avoid the man-in-the-middle, these instructions are sent over one or more of the plurality of channels 205-1 to 205-N which were not used to send the data set 301 or one or more copies of the source hash 303. Based on these instructions, the one or more of the plurality of channels 205-1 to 205-N is removed by the source processor 210 from the list of available channels 311.

The reduction in activity on a channel due to removal from the list of available channels 311, may alert an attacker such as man-in-the-middle 109 that they have been detected. Then, in step 421, one or more actions are taken to conceal detection from an attacker. In some embodiments, the one or more actions comprise source processor 210 generating encrypted dummy data, and source communications subsystem 208 transmitting the generated encrypted dummy data over the one or more of plurality of channels 205-1 to 205-N which were removed.

As explained above, in some embodiments, destination 203 is communicatively coupled to a different subsystem or device, and performs detection of man-in-the-middle attacks for that different subsystem or device. In some of these embodiments, destination processor 220 performs decryption of the encrypted data set and transmits the decrypted data to the different subsystem or device when a man-in-the-middle attack is not detected in step 419, that is, there is an absence of a man-in-the-middle attack. In other embodiments, destination processor 220 transmits the encrypted data set to the different subsystem or device when there is an absence of a man-in-the-middle attack.

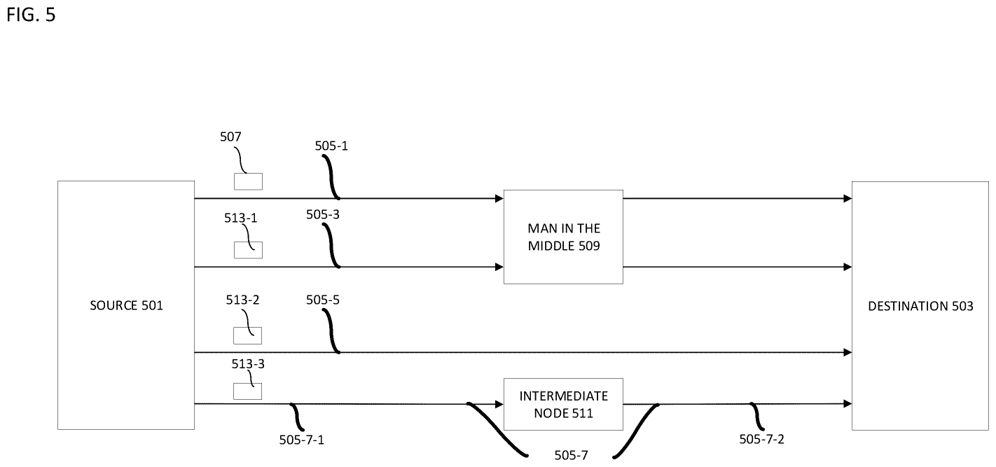

The system and method described in FIGS. 3 and 4 provide more protection against man-in-the-middle attacks, by improving detection capabilities. An example of this improvement in detection capabilities is shown with reference to FIG. 5. In FIG. 5, source 501 transmits encrypted data set 507 and copies of source hash 513-1 to 513-3 to destination 503 over plurality of channels 505-1, 505-3, 505-5 and 505-7. Channels 505-1, 505-3 and 505-5 are direct channels, while channel 505-7 is an indirect channel. Channel 505-7 comprises links 505-7-1 and 505-7-2 coupled to intermediate node 511.

In FIG. 5, man-in-the-middle 509 has inserted itself in the middle of either one or both of channels 505-1 and 505-3.

When man-in-the-middle 509 has inserted itself in the middle of channel 505-1, it is able to intercept, decrypt, and manipulate data set 507. However, when data set 507 is received and hashed at destination 503 as described above, and compared with copies 513-1, 513-2 and 513-3 of source hash as described above; there is a mismatch, leading to a determination of the presence of a possible man-in-the-middle attack at destination 503.

When man-in-the-middle 509 has inserted itself in the middle of channel 505-3, it is able to intercept and manipulate copy 513-1 of the source hash. However, when data set 507 is received and hashed at destination 503 as described above, and compared with copies 513-1, 513-2 and 513-3 of source hash as described above; there is a mismatch, leading to a determination of the presence of a possible man-in-the-middle attack at destination 503.

When man-in-the-middle 509 has inserted itself in the middle of channels 505-1 and 505-3 it is able to intercept, decrypt and manipulate data set 507 as described above. When man-in-the-middle 509 knows the hashing algorithm used to generate the one or more copies of the source hash, it is able to intercept copy 513-1 of the source hash and generate a hash that matches the manipulated data set. However, when data set 507 is received and hashed at destination 503 as described above, and compared with copies 513-1, 513-2 and 513-3 of source hash as described above; there is a mismatch, leading to a determination of the presence of a possible man-in-the-middle attack at destination 503.

Therefore, as long as there is at least one unintercepted channel between source 501 and destination 503, the presence of a possible man-in-the-middle attack can be detected. As one of skill in the art would appreciate, the detection capabilities increase with the number of channels used in the plurality of channels.

Furthermore, when the plurality of channels comprises one or more indirect channels, this increases the number of links which the man-in-the-middle must monitor. Therefore, having one or more indirect channels in the plurality of channels 205-1 to 205-N increases the resilience to attack. In some embodiments, one or more indirect channels are selected by the source processor 210 from the list of available channels 311 for inclusion in the plurality of channels so as to improve resilience to attack. In some embodiments, the channels in the list of available channels are indicated as either direct or indirect to enable the source processor to choose one or more indirect channels.

In some embodiments, the source communications subsystem 208 sends out an encrypted ping over one or more of the plurality of channels 205-1 to 205-N to obtain an indication of the quality of the one or more channels, that is, whether the plurality of channels have been compromised by a man-in-the-middle.

The above-described system and method is applicable in a variety of fields or spaces where there is a possibility of man-in-the-middle attacks. These include, for example, autonomous vehicles, robotics, secure file transmission, mesh network applications and Internet of Things (IOT) applications.

In one example embodiment, a system for detecting a man-in-the-middle attack on an encrypted set of data between a source and a destination, wherein a plurality of channels couples the source and the destination. The source comprises a source communications subsystem coupled to the plurality of channels, a source processor, and a source hashing subsystem. The source communications subsystem, source processor and source hashing subsystem are coupled with each other. The destination comprises a destination communications subsystem coupled to the plurality of channels, a destination hashing subsystem, a comparison subsystem, and a destination processor. The destination communications subsystem, destination hashing subsystem, comparison subsystem and destination processor are coupled with each other. The source hashing subsystem hashes the encrypted set of data to create one or more copies of a source hash. The source communications subsystem transmits the encrypted set of data to the destination using a first of the plurality of channels. The source communications subsystem transmits the one or more copies of the source hash to the destination using one or more of the plurality of channels other than the first channel. The destination communications subsystem receives the encrypted set of data from the first channel, and the one or more copies of the source hash from the one or more of the plurality of channels other than the first channel. The destination hashing subsystem hashes the received encrypted set of data to create a destination hash. The comparison subsystem compares the one or more copies of the source hash with each other and the destination hash. At least one of the comparison subsystem and the destination processor detects a presence or an absence of the man in the middle attack based on the comparison.

In one or more of the above examples, at least one of the plurality of channels comprises a plurality of links.

In one or more of the above examples, at least one of the plurality of links is coupled to an intermediate node.

In one or more of the above examples, the plurality of channels is selected from a list of available channels.

In one or more of the above examples, the selecting is based on one or more of signal quality, link quality, geolocation information, positional or motion information, and user input.

In one or more of the above examples, the selecting comprises prioritizing based on one or more of signal quality, link quality, geolocation information, positional or motion information, and user input.

In one or more of the above examples, the source processor removes one or more channels from the list of available channels based on the detection of the presence or the absence of the man-in-the-middle attack.

In one or more of the above examples, the source processor generates encrypted dummy data. The source communications subsystem then transmits the encrypted dummy data over the one or more channels removed from the list of available channels.

In one or more of the above examples, the plurality of channels comprises at least one indirect channel.

In one or more of the above examples, the plurality of channels comprises a first channel and a second channel. The first channel and the second channel occupy non-overlapping frequency ranges.

In one example embodiment, a method for detecting a man-in-the-middle attack on an encrypted set of data comprises hashing, by a source hashing subsystem within a source, the encrypted set of data to create a source hash; transmitting, by a source communications subsystem within the source, the encrypted set of data to a destination using a first channel which couples the source and the destination; transmitting, by the source communications subsystem, the source hash to the destination using a second channel which couples the source and the destination; hashing, by a destination hashing subsystem within the destination, the encrypted set of data to create a destination hash; comparing, by a comparison subsystem within the destination, the source hash with the destination hash; and detecting, by at least one of the comparison subsystem and a destination processor, a presence or an absence of the man-in-the-middle attack based on the comparing.

In one or more of the above examples, at least one of the first channel and the second channel comprises a plurality of links.

In one or more of the above examples, at least one of the plurality of links is coupled to an intermediate node.

In one or more of the above examples, the first channel and the second channel are selected from a list of available channels.

In one or more of the above examples, the first channel and the second channel are selected based on one or more of signal quality, link quality, geolocation information, positional or motion information, and user input.

In one or more of the above examples, selection of the first channel and the second channel comprises prioritizing based on one or more of signal quality, link quality, geolocation information, positional or motion information, and user input.

In one or more of the above examples, the source processor removes one or more channels from the list of available channels based on the detecting of a presence or an absence of the man-in-the-middle attack.

In one or more of the above examples, the source processor generates encrypted dummy data. The source communications subsystem transmits the encrypted dummy data over one or more channels removed from the list of available channels.

In one or more of the above examples, at least one of the first channel and the second channel comprises an indirect channel.

In one or more of the above examples, the first channel and the second channel occupy non-overlapping frequency ranges.

In one example embodiment, a system for detecting a man-in-the-middle attack on a first channel which couples a source and a destination, wherein a second channel couples the source and the destination. The source comprises a source communications subsystem coupled to the first and the second channels, a source processor, and a source hashing subsystem. The source communications subsystem, source processor and source hashing subsystem are coupled with each other. The destination comprises a destination processor, a destination communications subsystem coupled to the first and the second channels, a destination hashing subsystem, and a comparison subsystem. The destination communications subsystem, destination processor, comparison subsystem and source hashing subsystem are coupled with each other. The source processor creates an encrypted first set of data. The source hashing subsystem hashes the encrypted first set of data to create a source hash. The source communications subsystem transmits the encrypted first set of data to the destination using the first channel. The source communications subsystem transmits the source hash to the destination using the second channel. The destination communications subsystem receives the encrypted first set of data from the first channel and the source hash from the second channel. The destination hashing subsystem hashes the encrypted first set of data to create a destination hash. The comparison subsystem compares the source hash with the destination hash. At least one of the comparison subsystem and the destination processor detects a presence or an absence of the man in the middle attack based on the comparison.

In one or more of the above examples, a device is coupled to the source. The source receives a second set of data from the device. The source processor creates the encrypted first set of data based on the received second set of data.

In one or more of the above examples, the first and second channels are selected by the source processor from a list of available channels.

In one or more of the above examples, the list of available channels is selected by the source processor based on one or more of signal quality, link quality, geolocation information, positional or motion information, and user input.

In one or more of the above examples, at least one of the first channel and second channel is an indirect channel.

In one or more of the above examples, a device is coupled to the destination. The at least one of the comparison subsystem and the destination processor detects the presence or the absence of the man in the middle attack for the device coupled to the destination.

In one or more of the above examples, a first device is coupled to the source. A second device is coupled to the destination. The source receives a second set of data from the first device. The source processor creates the encrypted first set of data based on the received second set of data. The at least one of the comparison subsystem and the destination processor detects the presence or the absence of the man in the middle attack for the second device.

In one example embodiment, a method for detecting a man-in-the-middle attack on an encrypted set of data, the method comprising: hashing, by a source hashing subsystem within a source, the encrypted set of data to create one or more copies of a source hash; transmitting, by a source communications subsystem within the source, the encrypted set of data to a destination using a first of a plurality of channels, wherein the plurality of channels couples the source and the destination; transmitting, by the source communications subsystem, the one or more copies of the source hash to the destination using one or more channels from the plurality of channels other than the first channel; hashing, by a destination hashing subsystem within the destination, the encrypted set of data to create a destination hash; comparing, by a comparison subsystem within the destination, the one or more copies of the source hash with the destination hash; and detecting, by at least one of the comparison subsystem and a destination processor, a presence or an absence of the man-in-the-middle attack based on the comparing.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

What is claimed is:

1. A system for detecting a man-in-the-middle attack on an encrypted set of data between a source and a destination, wherein
a plurality of channels couples the source and the destination;
the source comprises
a source communications subsystem coupled to the plurality of channels,
a source processor, and
a source hashing subsystem, wherein
the source communications subsystem, source processor and source hashing subsystem are coupled with each other;
the destination comprises
a destination communications subsystem coupled to the plurality of channels,
a destination hashing subsystem,
a comparison subsystem, and
a destination processor, wherein
the destination communications subsystem, destination hashing subsystem, comparison subsystem and destination processor are coupled with each other; and further wherein
the source hashing subsystem hashes the encrypted set of data to create one or more copies of a source hash,
the source communications subsystem transmits the encrypted set of data to the destination using a first of the plurality of channels,
the source communications subsystem transmits the one or more copies of the source hash to the destination using one or more of the plurality of channels other than the first channel,
the destination communications subsystem receives
the encrypted set of data from the first channel, and
the one or more copies of the source hash from the one or more of the plurality of channels other than the first channel,
the destination hashing subsystem hashes the received encrypted set of data to create a destination hash,
the comparison subsystem compares the one or more copies of the source hash with each other and the destination hash, and
at least one of the comparison subsystem and the destination processor detects a presence or an absence of a man-in-the-middle attack based on the comparison.

2. The system of claim 1, wherein at least one of the plurality of channels comprises a plurality of links.

3. The system of claim 2, wherein at least one of the plurality of links is coupled to an intermediate node.

4. The system of claim 1, wherein the plurality of channels is selected by the source processor from a list of available channels.

5. The system of claim 4, wherein the selecting is based on one or more of:
signal quality;
link quality;
geolocation information;
positional or motion information; and
user input.

6. The system of claim 5, wherein the selecting comprises prioritizing based on one or more of:
signal quality;
link quality;
geolocation information;
positional or motion information; and
user input.

7. The system of claim 4, wherein the source processor removes one or more channels from the list of available channels based on the detection of the presence or the absence of the man-in-the-middle attack.

8. The system of claim 7, wherein
the source processor generates encrypted dummy data; and
the source communications subsystem transmits the encrypted dummy data over the one or more channels removed from the list of available channels.

9. The system of claim 1, wherein the plurality of channels comprises at least one indirect channel.

10. The system of claim 1, wherein the plurality of channels comprises a first channel and a second channel; and
the first channel and the second channel occupy non-overlapping frequency ranges.

11. A method for detecting a man-in-the-middle attack on an encrypted set of data, wherein the method comprises:
hashing, by a source hashing subsystem within a source, the encrypted set of data to create a source hash;
transmitting, by a source communications subsystem within the source, the encrypted set of data to a destination using a first channel which couples the source and the destination;
transmitting, by the source communications subsystem, the source hash to the destination using a second channel which couples the source and the destination;
hashing, by a destination hashing subsystem within the destination, the encrypted set of data to create a destination hash;
comparing, by a comparison subsystem within the destination, the source hash with the destination hash; and
detecting, by at least one of the comparison subsystem and a destination processor, a presence or an absence of the man-in-the-middle attack based on the comparing.

12. The method of claim 11, wherein at least one of the first channel and the second channel comprises a plurality of links.

13. The method of claim 12, wherein at least one of the plurality of links is coupled to an intermediate node.

14. The method of claim 11, further comprising selecting, by the source processor, the first channel and the second channel from a list of available channels.

15. The method of claim 14, wherein the selecting is based on one or more of:
signal quality;
link quality;
geolocation information;
positional or motion information; and
user input.

16. The method of claim 15, wherein the selecting comprises prioritizing based on one or more of:
signal quality;
link quality;
geolocation information;
positional or motion information; and
user input.

17. The method of claim 14, further comprising removing, by the source processor, one or more channels from the list of available channels based on the detecting.

18. The method of claim 17, further comprising
generating, by the source processor, encrypted dummy data; and
transmitting, by the source communications subsystem, the encrypted dummy data over the one or more channels removed from the list of available channels.

19. The method of claim 11, wherein at least one of the first channel and the second channel comprises an indirect channel.

20. A system for detecting a man-in-the-middle attack on a first channel which couples a source and a destination, wherein:
a second channel couples the source and the destination;
the source comprises
a source communications subsystem coupled to the first and the second channels,
a source processor, and
a source hashing subsystem, wherein
the source communications subsystem, source processor and source hashing subsystem are coupled with each other;
the destination comprises
a destination processor,
a destination communications subsystem coupled to the first and the second channels,
a destination hashing subsystem, and
a comparison subsystem, wherein
the destination communications subsystem, destination processor, comparison subsystem and source hashing subsystem are coupled with each other; and
further wherein
the source processor creates an encrypted first set of data,
the source hashing subsystem hashes the encrypted first set of data to create a source hash,
the source communications subsystem transmits the encrypted first set of data to the destination using the first channel,
the source communications subsystem transmits the source hash to the destination using the second channel,
the destination communications subsystem receives the encrypted first set of data from the first channel and the source hash from the second channel,
the destination hashing subsystem hashes the encrypted first set of data to create a destination hash,
the comparison subsystem compares the source hash with the destination hash, and
at least one of the comparison subsystem and the destination processor detects a presence or an absence of a man-in-the-middle attack based on the comparison.
